(19) United States
(12) Patent Application Publication
(10) Pub. No.: US 2008/0047126 A1
(43) Pub. Date: Feb. 28, 2008

(54) Method of manufacture a cup face with different thickness distribution

(76) Inventor: Archer C.C. Chen, Taichung (TW)

Correspondence Address: BROWDY AND NEIMARK, P.L.L.C.;624 NINTH STREET, NW, SUITE 300, WASHINGTON, DC, 20001-5303, US

(21) Appl. No.: 11/504,067

(22) Filed: Aug. 15, 2006

(51) Int. Cl. B23P 13/04; B21D 31/00

(52) U.S. Cl. 29/557; 29/558; 72/379.2

(57) ABSTRACT

A method of manufacture a cup face with different thickness distribution is cutting a slice metal board with predestination shape from a metal board and stamping the slice metal board into an uneven metal board with predestination shape of rough and uneven on it then, milling one side of the uneven metal board to produce a board with different thickness. The final step is pressing the metal board with different thickness into a cup shape to form a cup face with different thickness distribution.

### BACKGROUND OF THE INVENTION

1. Field of the Invention

The present invention relates to a method of manufacture a golf head and more particularly to a method of manufacture a cup face with different thickness distribution.

2. Description of the Related Art

In prior art, a cup face usually make of metal rod by forging and the pressure of the forging must higher than 400 tons and loses about 50% of the stuff. As a result of the crystals will change and reduce the strength of the material when the temperature is higher than 800° C. The manufacture temper must be controlled under 800° C. if manufacturer uses β titanium material to make the cup face. But, this will be very difficult to make a metal rod into a cup face with the thickness between 1.5 to 4 mm by forging under the low manufacture temperature. The damnation of the cup face will be difficult to control.

### SUMMARY OF THE INVENTION

The object of the present invention is to provide a method of manufacture a cup face with different thickness distribution and the product is excellence in quality.

To achieve this object of the present invention, the method in present invention, comprising: cutting a slice metal board with predestination shape from a metal board (like β titanium material or maraging steel) and stamping the slice metal board into an uneven metal board with predestination shape of rough and uneven on it then, milling the uneven metal board to produce a board with different thickness. The final step is pressing the metal board with different thickness into a cup shape to form a cup face with different thickness.

The advantage of present invention is using a board material to manufacture. The method of present invention loses about 20˜30% stuff and saves cost. By this method, there is no high pressure machine needed and the cost of equipment can be saved. It is easy to control the thickness distribution by pressing a flat board first and then milling one side of it.

### BRIEF DESCRIPTION OF THE DRAWINGS

FIG. 1 is a front view of a board that cuts from the first step of the present invention;

FIG. 2 is a section view along the line 2-2 of the FIG. 1;

FIG. 3 is a front view of a board with rough and uneven in surface that presses in the second step of the present invention;

FIG. 4 is a section view along the line 4-4 of the FIG. 3;

FIG. 5 is a front view of a board with rough and uneven in surface that mills in the third step of present invention.

FIG. 6 is a section view along the line 6-6 of the FIG. 5;

FIG. 7 is a front view of a cup face that presses in the forth step of present invention;

FIG. 8 is a section view along the line 8-8 of the FIG. 7;

### DETAILED DESCRIPTION OF THE INVENTION

Referring to FIGS, a method of manufacture a cup face with different thickness distribution of present invention, comprising:

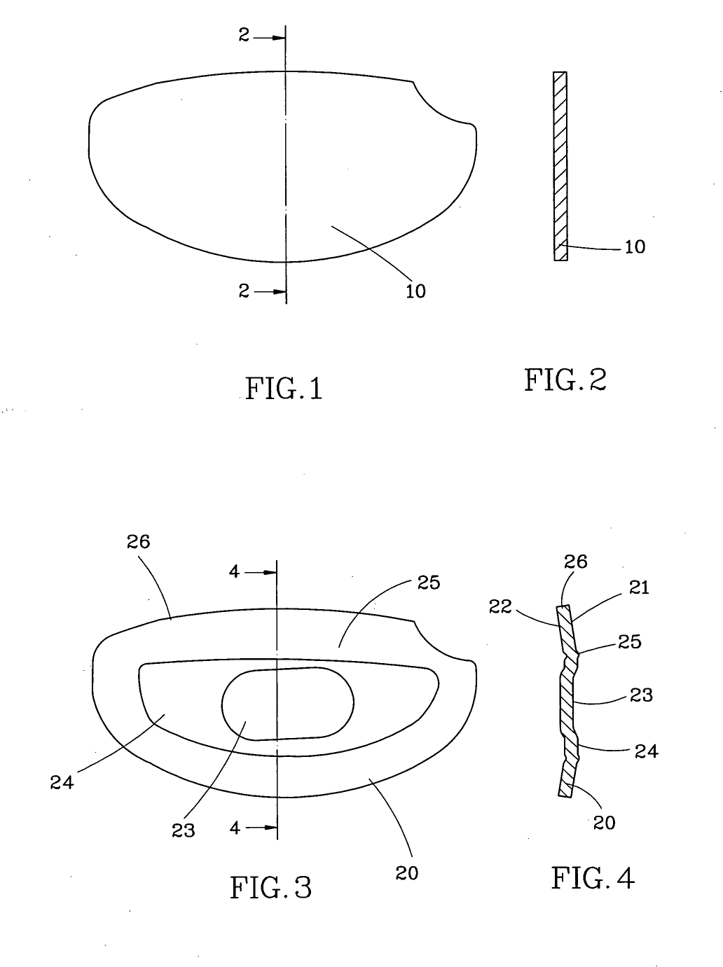

The first step is cutting a slice metal board 10 with predestination shape (the unfold shape of the cup face) from a metal board (like β titanium material or maraging steel) as shows in FIG. 1 and FIG. 2.

The second step is stamping the slice metal board 10 of the first step into an uneven metal board 20 with predestination shape of rough and uneven on it as shows in FIG. 3 and FIG. 4. In order to make the metal board become thinner, the manufacturer need to press the metal board on same side.

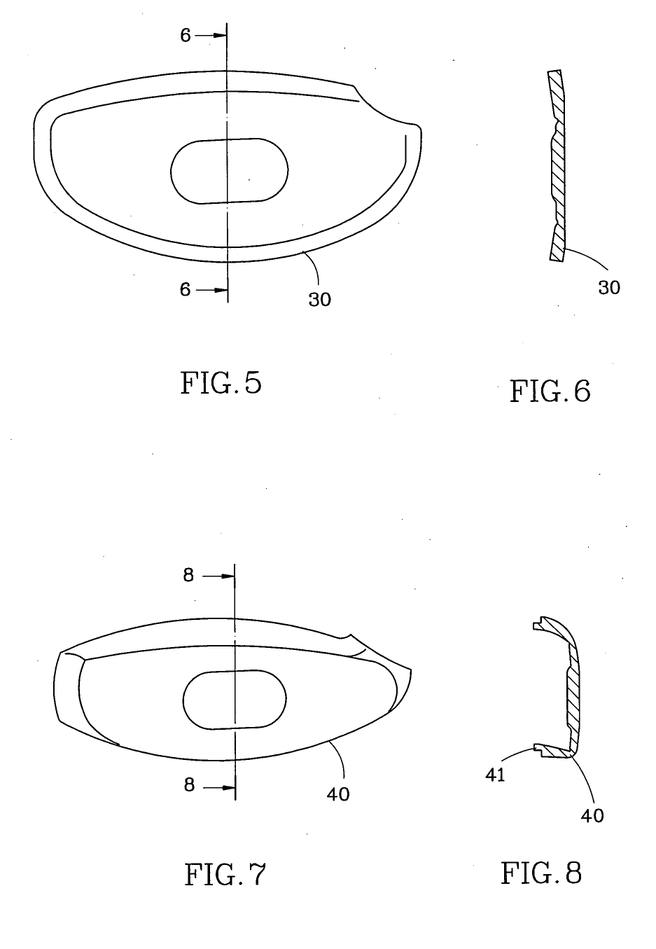

The third step is milling one side of the uneven metal board 20 of the second step to produce a board with different thickness as shows in FIG. 5 and FIG. 6. This step mills the protruding side 21 of the uneven metal board 20 and makes the protruding side flat. This step makes the uneven metal board 20 become a metal board 30 with different thickness.

The fourth step is pressing the metal board 30 with different thickness of the third step into a cup shape as shows in FIG. 7 and FIG. 8 to form a cup face with different thickness distribution.

The final step is milling partial of the edge of the cup face 40 and forms a protrudent portion 41 for the following manufacture process.

The second step is pressing the central portion of the metal board 20 as mark 23 on the FIG. to another side 22. The portion as mark 24 on the FIG. is almost flat. The rising portion 25 around the flat portion 24 protrudes to the side 21. The third step is milling the side 21 even with the central portion 23 as shows in FIG. 5 and FIG. 6. The central portion 23 keeps the original thickness of the board and the flat portion 24 mills partial thickness. The rising portion 25 mills most of the thickness and forms the thinnest portion. The most thickness of the central portion 23 forms the center portion of the cup face as shows in FIG. 7 and FIG. 8. The board is bended at thinnest rising portion 25 to form a cup shape but the edge portion 26 still keeps the thickness of the board to from the protrudent portion 41 as aforesaid.

Present invention provides a simple cutting, stamping, milling and forging steps and makes a flat board to become a cup face with different thickness. The steps of present invention are simple and no expensive equipment is needed. The method of present invention can operate in the low temperature without breaking the strength of the material. The product can be excellent in dimension and good quality. The method of present invention also saves stuff and cost.

What is claimed is:

1. A method of manufacture a cup face with different thickness distribution, comprising:
the first step is cutting a slice metal board with predestination shape from a metal board;
the second step is stamping the slice metal board of the first step into an uneven metal board with predestination shape of rough and uneven on it;
the third step is milling one side of the uneven metal board of the second step to produce a board with different thickness;
the fourth step is pressing the metal board with different thickness of the third step into a cup shape to form a cup face with different thickness distribution.

2. The method as claimed in claim 1, wherein the second step is pressing the central portion of the slice metal board of the first step to another side; the board forms a flat portion around the central portion and the portion around the flat portion protrudes to the other side and forms a rising portion.

3. The method as claimed in claim 1, wherein the third step is milling the rising side of the uneven metal board of the second step even with the central portion.
